(19) United States
(12) Patent Application Publication
(10) Pub. No.: US 2005/0109427 A1
(43) Pub. Date: May 26, 2005

(54) Magnetic alloy, magnetic recording medium, and magnetic recording and reproducing apparatus

(75) Inventors: Takao Suzuki, Nagoya-shi (JP); Hiroshi Kanazawa, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignees: SHOWA DENKO K.K., Minato-ku (JP); TOYOTA SCHOOL FOUNDATION, Nagoya-shi (JP)

(21) Appl. No.: 10/628,242

(22) Filed: Jul. 29, 2003

Related U.S. Application Data
(60) Provisional application No. 60/399,398, filed on Jul. 31, 2002.

(30) Foreign Application Priority Data
Jul. 29, 2002 (JP) 2002-219084

(51) Int. Cl. H01F 1/047

(52) U.S. Cl. 148/300; 148/315

(57) ABSTRACT

A magnetic alloy comprises Pt in an amount of 40 at % to 60 at %, and at least two 3d transition metal elements, wherein the total amount of the 3d transition metal elements is from 60 at % to 40 at %, and the average number of valence electrons in the respective 3d transition metal elements as calculated on the basis of the compositional proportions of the elements is from 7.5 to 9.

### CROSS-REFERENCE TO RELATED APPLICATIONS

This application claims benefit of Provisional Application 60/399,398 filed Jul. 31, 2002, incorporated herein by reference, under 35 U.S.C. § 111(b) pursuant to 35 U.S.C. § 119(e) (1).

### BACKGROUND OF THE INVENTION

1. Field of the Invention

The present invention relates to a magnetic alloy, to a magnetic recording medium, and to a magnetic recording and reproducing apparatus incorporating the magnetic recording medium.

2. Background Art

The recording density of a hard disk device (HDD), which is a magnetic recording and reproducing apparatus, has increased at a rate of 60% or more per year, and this tendency is expected to continue. Therefore, magnetic recording heads and magnetic recording media which are suitable for attaining high recording density are now under development.

Most commercially available magnetic recording media employed in magnetic recording and reproducing apparatuses are of a longitudinal recording type, in which easy-magnetization axes in a magnetic film are oriented horizontally with respect to the substrate. The term “easy-magnetization axis” refers to an axis along which magnetization occurs easily. In the case of a Co-based alloy, the c axis of a Co hcp structure is an easy-magnetization axis.

When recording density is increased in such a longitudinal magnetic recording medium, the per-bit volume of a magnetic layer becomes excessively small, and recording and reproduction characteristics of the medium may deteriorate for reasons of thermal instability.

In contrast, in a perpendicular magnetic recording medium in which easy-magnetization axes in a magnetic film are oriented generally perpendicular to a substrate, even when recording density is increased, effects attributable to demagnetization field in the recording bit are insignificant, and clear bit boundaries are formed, thus enabling noise reduction. Furthermore, even when recording density is increased, reduction in recording bit volume can be suppressed, and thus thermal stability can be enhanced. Therefore, in recent years, a perpendicular magnetic recording medium has become of keen interest, and a medium structure suitable for perpendicular magnetic recording has been proposed.

For example, Japanese Patent No. 2615847 discloses a perpendicular magnetic layer having a multi-layer structure including a first layer formed of a magnetic material having a low Co content and a second layer formed of a magnetic material having a high Co content, the second layer being provided atop the first layer. Japanese Patent No. 3011918 discloses a technique similar to that disclosed in the above publication, in which an upper magnetic layer provided atop a lower magnetic layer which is close to a substrate is formed of a magnetic material having a Co content higher than that of the material of the lower magnetic layer and exhibiting high saturation magnetization (Ms) and magnetic anisotropy constant (Ku), to thereby enhance recording and reproduction characteristics, as well as thermal stability.

In response to demand for magnetic recording media of higher recording density, employment of a single-pole head exhibiting excellent ability to record data onto a perpendicular magnetic layer has been proposed. In order to realize employment of such a head, there has been proposed a magnetic recording medium in which a layer formed of a soft magnetic material (called a “backing layer”) is provided between a substrate and a perpendicular magnetic layer serving as a recording layer, to thereby enhance efficiency in magnetic flux flow between the single-pole head and the medium.

However, the aforementioned magnetic recording medium in which a backing layer is simply added is not satisfactory in terms of recording and reproduction characteristics, thermal stability, and recording resolution, and thus demand has arisen for a magnetic recording medium which is excellent in terms of these characteristics.

In order to enhance thermal stability, a magnetic alloy employed in a perpendicular magnetic layer is required to have a high magnetic anisotropy constant (Ku). This is because direction of a recording bit of such magnetic alloy cannot reverse easily.

### SUMMARY OF THE INVENTION

In order to solve the aforementioned problems, the present inventors have performed extensive studies, and consequently have developed a magnetic alloy, a magnetic recording medium, and a magnetic recording and reproducing apparatus incorporating the medium, which are described below. Accordingly, the present invention provides the following.

(1) A magnetic alloy comprising Pt in an amount of 40 at % to 60 at %, and at least two 3d transition metal elements, wherein the total amount of the 3d transition metal elements is from 60 at % to 40 at %, and the average number of valence electrons in the respective 3d transition metal elements as calculated on the basis of the compositional proportions of the elements is from 7.5 to 9.

(2) A magnetic alloy according to (1), which has an order parameter (S) of 0.5 to 1 as calculated from the following formula:
S=[{F(002)²/F(001)²}×{L(002)/L(001)}×{A(002)/A(001)}×{I(001)/I(002)}]^{1/2}
wherein F(plane direction), L(plane direction), A(plane direction), and I(plane direction) represent the structure factor, Lorentz factor, absorption factor, and integration intensity as measured through X-ray diffractometry (θ/2θ) of the magnetic alloy in the corresponding plane direction, respectively.

(3) A magnetic alloy according to (1) or (2), which has a magnetic anisotropy constant (Ku) of 8×10⁵ J/K to 2×10⁷ J/K.

(4) A magnetic recording medium comprising a substrate, a soft magnetic layer, a perpendicular magnetic layer, and a protective layer, the layers being provided atop the substrate, wherein the perpendicular magnetic layer contains a magnetic alloy as recited in any one of (1) through (3).

(5) A magnetic recording and reproducing apparatus comprising a magnetic recording medium as recited in (4), and a magnetic head for recording of data onto the medium and for reproduction of the data therefrom.

### DETAILED DESCRIPTION OF THE INVENTION

A characteristic feature of the magnetic alloy of the present invention resides in that the alloy contains Pt in an amount of 40 at % to 60 at %, and at least two 3d transition metal elements, wherein the total amount of the 3d transition metal elements falls within a range of 60 at % to 40 at %, and the average number of valence electrons in the respective 3d transition metal elements as calculated on the basis of the compositional proportions of the elements falls within a range of 7.5 to 9.

According to the present invention, a magnetic alloy having high Ku is obtained. When the magnetic alloy is employed in a perpendicular magnetic layer of a magnetic recording medium, lattice strain between the perpendicular magnetic layer and a soft magnetic layer can be reduced.

The magnetic alloy of the present invention may contain, in addition to Pt and the 3d transition metal elements, an element which exerts an auxiliary effect on the alloy.

The 3d transition metal elements incorporated in the magnetic alloy of the present invention are specifically Cr, Mn, Fe, Co, Ni, and Cu. The number of valence electrons in each of these 3d transition metal elements refers to the number of electrons in the 3d and 4s orbitals of the element. The valence electron numbers of Cr, Mn, Fe, Co, Ni, and Cu are 6, 7, 8, 9, 10, and 11, respectively.

A characteristic feature of the magnetic alloy of the present invention resides in that the alloy contains two or more of these 3d transition metal elements with Pt, which forms L1₀ structure. When the compositional proportions of the 3d transition metal elements are varied in consideration of the number of valence electrons, high magnetic anisotropy can be obtained. In the magnetic alloy of the present invention, the total amount of the 3d transition metal elements preferably falls within a range of 60 at % to 40 at %, more preferably 55 at % to 45 at %.

When the total amount of the 3d transition metal elements exceeds 60 at %, the structure of the magnetic alloy changes from L1₀ to another structure, whereby the magnetic anisotropy constant (Ku) thereof is lowered. In contrast, when the total amount of the 3d transition metal elements is less than 40 at %, Ku is lowered in accordance with an increase in the Pt content.

In the magnetic alloy of the present invention, the average number of valence electrons in the respective 3d transition metal elements as calculated on the basis of the compositional proportions of the elements preferably falls within a range of 7.5 to 9, more preferably 7.8 to 8.5. The average number of valence electrons in the respective 3d transition metal elements is calculated as follows. For example, in the case of a Pt₆₀Fe₂₀Ni₂₀ alloy (“Pt₆₀Fe₂₀Ni₂₀” indicates that the alloy contains Pt (60 at %), Fe (20 at %), and Ni (20 at %), the same convention shall apply hereinafter), the alloy contains Fe and Ni (i.e., 3d transition metal elements) at a ratio of 1:1, and thus the average number of valance electrons is 9. In the case of a Pt₆₀Fe₂₀Co₂₀ alloy, the average number of valance electrons is 8.5, and, in the case of a Pt₆₀Fe₃₀Co₁₀ alloy, the average number of valence electrons is 8.25.

In the magnetic alloy of the present invention, when the average number of valence electrons in the respective 3d transition metal elements as calculated on the basis of the compositional proportions of the elements is less than 7.5 or more than 9, high Ku value fails to be obtained.

The magnetic alloy of the present invention preferably has an order parameter (S) of 0.5 to 1, more preferably 0.8 to 1, as calculated from the following formula (2). When the order parameter (S) is less than 0.5, high Ku value fails to be obtained. The order parameter is calculated through the below-described procedure. The upper limit of the order parameter (S) is 1.
S=[{F(002)²/F(001)²}×{L(002)/L(001)}×{A(002)/A(001)}×{I(001)/I(002)}]^{1/2} (2)

wherein F(plane direction), L(plane direction), A(plane direction), and I(plane direction) represent the structure factor, Lorentz factor, absorption factor, and integrated intensity as measured through X-ray diffractometry (θ/2θ) of the magnetic alloy in the corresponding plane direction, respectively. Table 1 shows atomic scattering factor, Lorentz factor, and mass absorption coefficient, which are employed for actual calculation. These values were measured through X-ray diffractometry employing Cu-Kα rays as an X-ray source. In Table 1, “hkl” shows the plane direction of the element.

TABLE 1
Atomic scattering factor (f)

| hkl | f(Ptₕₖₗ) | f(Crₕₖₗ) | f(Mnₕₖₗ) | f(Feₕₖₗ) | f(Coₕₖₗ) | f(Niₕₖₗ) | f(Cuₕₖₗ) |
|---|---|---|---|---|---|---|---|
| 001 | 71.0 | 20.1 | 20.2 | 22.3 | 23.3 | 24.2 | 24.8 |
| 002 | 61.3 | 15.5 | 15.6 | 17.8 | 18.6 | 19.5 | 19.6 |

Lorentz factor (L)

| hkl | L(hkl) |
|---|---|
| 001 | 4.55 |
| 002 | 1.90 |

Mass absorption coefficient (μ/ρ) for each element

| Cr | Mn | Fe | Co | Ni | Cu | Pt |
|---|---|---|---|---|---|---|
| 252.3 | 284 | 304.4 | 338.6 | 48.83 | 52.7 | 198.2 |

The structure factor is represented by the following formulas:
F(001)=f((3d transition metal element)₀₀₁)−f(Pt₀₀₁)
F(002)=f((3d transition metal element)₀₀₂)+f(Pt₀₀₂)
(wherein f represents an atomic scattering factor). In these formulas, f((3d transition metal element)₀₀₁) and f((3d transition metal element)₀₀₂) refer to the average of the atomic scattering factors of the 3d transition metal elements contained in the magnetic alloy at each plane. For example, when the alloy contains Fe and Co at a ratio of 2:1, f((3d transition metal element)₀₀₁) and f((3d transition metal element)₀₀₂) are obtained by use of the following formulas.
f((3d transition metal element)₀₀₁)={f(Fe₀₀₁)×2+f(Co₀₀₁)×1}/3
f((3d transition metal element)₀₀₂)={f(Fe₀₀₂)×2+f(Co₀₀₂)×1}/3

L(001) and L(002) are Lorentz factors, and are represented by the following formula:
L(plane direction)=(1+cos²2θ/sin 2θ).

In the case of a perpendicular recording medium, the easy-magnetization axes must be oriented in a vertical direction. The Lorentz factors can be employed as the θ/2θ measurement values of a perpendicular recording medium. Since these values are almost the same between elements, the values shown in Table 1 are employed.

A(001) and A(002) are absorption factors, and are represented by the following formula:
A(plane direction)=1−exp(−2μd/sin θ)
(wherein μ represents a linear absorption coefficient, and d represents a thickness (unit: cm)).

The μ value of the alloy (μ_{Alloy}) is obtained by use of mass absorption coefficient (μ/ρ) shown in Table 1, so as to reflect the mass ratio on the μ value as described below.
μ_{Alloy}=ρ_{Alloy}[w₁(μ/ρ)₁+w₂(μ/ρ)₂+ . . . ]
(wherein μ_{Alloy}, ρ_{Alloy}, w₁, and (μ/ρ)₁ represent the linear absorption coefficient of the alloy, the density of the alloy, the mass % of one element (1) of the alloy, and the mass absorption coefficient of element (1) of the alloy, respectively, w₂ and (μ/ρ)₂ represent the mass % of a second element (2) of the alloy and the mass absorption coefficient of element (2) of the alloy, respectively, and so on).

The magnetic alloy of the present invention preferably has a magnetic anisotropy constant (Ku) of 8×10⁵ J/K to 2×10⁷ J/K. When Ku falls within the above range, the magnetic alloy can be employed as a promising permanent magnet material. In addition, when the magnetic alloy is employed in a magnetic recording medium, the medium exhibits enhanced thermal stability.

Ku is calculated through the following procedure.

(1) A magnetic film (thickness: 50 nm (500 Å)) is formed on an MgO single crystal substrate (plane direction (100)).

(2) A torque curve is obtained by use of a torque magnetometer under application of a magnetic field of 10 kOe (1 Oe=about 79 A/m), 15 kOe, 20 kOe, 25 kOe, or 30 kOe. From these results, the magnetic torque under each external field can be estimated using Fourier series expansion by sin 2α value (wherein α represents an angle formed between the direction of the applied magnetic field and an easy-magnetization axis).

(3) The thus-obtained value is plotted against the inverse number of the applied magnetic field. Here, infinite limit of magnetic torque (Tmag) is defined using a straight line to y axis by the least squares method.

(4) Saturation magnetization (Ms) is obtained from a magnetization curve obtained by use of a vibrating sample magnetometer (VSM).

(5) Ku is calculated by use of the following formula: Ku=2πMs²+Tmag.

In the aforementioned calculation procedure, when the intensity of the applied magnetic field is increased; i.e., when hard-magnetization axes are oriented in a magnetization direction, and more accurate measurement is performed, the Tmag value tends to become large, and the thus-obtained Ku value is considered to become lower than the real value.

In a magnetic recording medium including a substrate, a soft magnetic layer, a perpendicular magnetic layer, and a protective layer, the layers being provided atop the substrate, preferably, the perpendicular magnetic layer is formed of the magnetic alloy of the present invention. When the perpendicular magnetic layer is formed of the magnetic alloy of the present invention, the resultant magnetic recording medium exhibits enhanced thermal stability.

The magnetic recording medium containing the magnetic alloy of the present invention preferably constitutes a magnetic recording and reproducing apparatus together with a magnetic head for recording of data onto the medium and for reproduction of the data therefrom. The magnetic recording and reproducing apparatus incorporating the magnetic recording medium containing the magnetic alloy of the present invention exhibits enhanced thermal stability and considerably high recording density.

### EXAMPLES

### Examples 1 to 5

A magnetic film was formed on the surface of an MgO single crystal substrate (plane direction (100)) by use of an electron beam evaporation apparatus. The temperature of the substrate was regulated to 500° C., and the thickness of the film was regulated to 500 Å.

Magnetic characteristics of the thus-formed magnetic film were measured. The order parameter (S) was measured through X-ray diffractometry (θ/2θ), and Ku was calculated by use of a torque magnetometer (applied maximum magnetic field: 30 kOe). The composition of the magnetic film (magnetic alloy) and measurement results are shown in Table 2 for Examples 1 to 5, which differed from each other only in the composition of the magnetic film.

### Comparative Examples 1 through 3

In a manner similar to that of Examples 1 to 5, comparative magnetic films made from magnetic alloys that were not in accordance with the present invention were formed, and the magnetic characteristics of the film were measured.

The composition of the comparative magnetic films and measurement results are shown in Table 2.

TABLE 2

| | | Valence | | |
|---|---|---|---|---|
| | | electron | | |
| | Composition | number | S | Ku (J/K) |
| Example 1 | Cr12Fe36Pt52 | 7.55 | 0.85 | 2.1 × 10⁶ |
| Example 2 | Fe25Co30Pt45 | 8.55 | 0.65 | 2.4 × 10⁶ |
| Example 3 | Fe38Co10Ni5Pt47 | 8.38 | 0.7 | 3.8 × 10⁶ |
| Example 4 | Mn4Fe32Co10Cu4Pt50 | 8.36 | 0.88 | 1.6 × 10⁶ |
| Comparative | Ni50Pt50 | 10 | 0.7 | 0 |
| Example 1 | | | | |
| Comparative | Cr25Fe25Pt50 | 7 | 0.63 | 0 |
| Example 2 | | | | |
| Comparative | Co25Ni25Pt50 | 9.5 | 0.6 | 3.0 × 10⁵ |
| Example 3 | | | | |
| Example 5 | Cr12Fe38Pt50 | 7.5 | 0.4 | 3.2 × 10⁵ |

Employment of the magnetic alloy of the present invention can provide a permanent magnet material exhibiting excellent magnetic characteristics, as well as a magnetic recording and reproducing apparatus exhibiting enhanced thermal stability and considerably high recording density.

While the invention has been described in detail and with reference to specific embodiments thereof, it will be apparent to one skilled in the art that various changes and modifications can be made therein without departing from the spirit and scope thereof.

This application is based on Japanese Patent Application No. P2002-219084 filed Jul. 29, 2002, incorporated herein by reference in its entirety.

1. A magnetic alloy comprising Pt in an amount of 40 at % to 60 at %, and at least two 3d transition metal elements, wherein the total amount of the 3d transition metal elements is from 60 at % to 40 at %, and the average number of valence electrons in the respective 3d transition metal elements as calculated on the basis of the compositional proportions of the elements is from 7.5 to 9.

2. A magnetic alloy according to claim 1, which has an order parameter (S) of 0.5 to 1 as calculated from the following formula:
S=[{F(002)²/F(001)²}×{L(002)/L(001)}×{A(002)/A(001)}×{I(001)/I(002)}]^{1/2}
wherein F(plane direction), L(plane direction), A(plane direction), and I(plane direction) represent the structure factor, Lorentz factor, absorption factor, and integration intensity as measured through X-ray diffractometry (θ/2θ) of the magnetic alloy in the corresponding plane direction, respectively.

3. A magnetic alloy according to claim 1 or 2, which has a magnetic anisotropy constant (Ku) of 8×10⁵ J/K to 2×10⁷ J/K.

4. A magnetic recording medium comprising a substrate, a soft magnetic layer, a perpendicular magnetic layer, and a protective layer, the layers being provided atop the substrate, wherein the perpendicular magnetic layer contains a magnetic alloy as recited in claim 1 or 2.

5. A magnetic recording and reproducing apparatus comprising a magnetic recording medium as recited in claim 4, and a magnetic head for recording of data onto the medium and for reproduction of the data therefrom.
